(19) United States
(12) Patent Application Publication
(10) Pub. No.: US 2005/0216908 A1
(43) Pub. Date: Sep. 29, 2005

(54) Assigning computational processes in a computer system to workload management classes

(76) Inventors: Susann Marie Keohane, Austin, TX (US); Gerald Francis McBrearty, Austin, TX (US); Shawn Patrick Mullen, Buda, TX (US); Jessica Murillo, Hutto, TX (US); Johnny Meng-Han Shieh, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 10/809,552

(22) Filed: Mar. 25, 2004

(51) Int. Cl. G06F 9/44; G06F 9/445

(52) U.S. Cl. 717/174; 717/116

(57) ABSTRACT

Assigning computational processes in a computer system to workload management classes that include installing on the computer system an executable file from a software installation package. The software installation package typically includes a specification of workload management properties for the executable file which in turn includes a definition of a workload management class. Typical embodiments also include executing a process in dependence upon the executable file and assigning the process to the workload management class. In typical embodiments, the workload management class definition also includes a class name, a priority ranking, and an inheritance attribute. In typical embodiments, the specification of workload management properties also includes minimum values and maximum values for CPU, memory, and disk I/O shares for the executable file.

### BACKGROUND OF THE INVENTION

1. Field of the Invention

The field of the invention is data processing, or, more specifically, methods, systems, and products for assigning computational processes in a computer system to workload management classes.

2. Description Of Related Art

Many traditional operating systems, including most Unix-style operating systems as well as Microsoft's Windows NT™, manage processes by means of preemptive dispatching—where processes are scheduled by priority and then first-in-first-out. Memory management allocated a preset quantity of virtual memory space mapped at runtime to physical memory. Disk I/O bandwidth was not regulated at the process level. Another way of managing system resources, called ‘workload management’ and previously available mainly on mainframe operating systems such as IBM's OS/390™, however, is becoming available on Unix systems also. Workload management (“WLM”) is an operating system feature that provides an ability to control how scheduling, memory management, and device driver calls allocate CPU, physical memory, and I/O bandwidth to computational processes assigned to classes which in turn have associated allocations of resources. Workload management allows a hierarchy of classes to be specified, processes to be automatically assigned to classes by the characteristics of a process, and manual assignment of processes to classes. Resource share definitions support automated adjustment of resource allocations when there are no jobs in a class or when a class does not use all the resources that are allocated for it. The resources will automatically be distributed to other classes to match the policies of the system administrator. Since the scheduling may be done within a single operating system, as opposed to scheduling separately for partitioned instances of an operating system, system management is less complex.

The central concept of workload management is the class. A class is a collection of computational processes that has a single set of resource limits applied to it. Computational processes are sometimes referred to as jobs, tasks, threads, programs, or applications. In this specification, computational processes are referred to as ‘processes.’ WLM assigns processes to various classes and controls the allocation of system resources among the classes. WLM uses class assignment rules and per-class resource shares and limits set by a system administrator or other authorized users. In this specification, the term ‘system administrator’ is used for efficiency and clarity to refer to both a system administrator and also to any other user authorized to carry out workload management operations. Resource entitlements and limits in WLM are enforced at the class level. This is a way of defining classes of service and regulating the resource utilization of each class of applications or processes to prevent applications with very different resource utilization patterns from interfering with each other when they are sharing a single server.

Typical workload management provides only two ways to assign a process to a workload management class: (1) automatic assignment, when the task is executed, according to workload management rules set by a system administrator and (2) manual assignment by a system administrator after the process is created. In typical workload management, the application of automated assignment rules at execution time cannot be turned off. There are many processes to be administered, and the use of automated rules, no matter how sophisticated, does not always effect resource assignments that meet all the administrative and business goals of every administrator. Both the creation of the rules and any necessary fine tuning by use of manual assignments are laborious.

### SUMMARY OF THE INVENTION

Methods, systems, and products are described for assigning computational processes in a computer system to workload management classes that provide class assignments upon application installation, class assignments that operate independently at run-time to override the usual WLM class assignment rules, thereby offloading from the system administrator the need for rules development and manual class assignment. More particularly, methods, systems, and products are described for assigning computational processes in a computer system to workload management classes that include installing on the computer system an executable file from a software installation package.

The software installation package typically includes a specification of workload management properties for the executable file which in turn includes a definition of a workload management class. Typical embodiments also include executing a process in dependence upon the executable file and assigning the process to the workload management class. In typical embodiments, the workload management class definition also includes a class name, a priority ranking, and an inheritance attribute. In typical embodiments, the specification of workload management properties also includes minimum values and maximum values for CPU, memory, and disk I/O shares for the executable file.

In typical embodiments, installing an executable file also includes configuring the workload management class in dependence upon the workload management properties and storing a class name of the workload management class in association with a pathname for the executable file. In typical embodiments, installing an executable file further includes storing a class name for the workload management class in association with a pathname for the executable file. In typical embodiments, assigning the process to the workload management class also includes identifying the workload management properties for the workload management class in dependence upon the pathname and configuring the workload management class in dependence upon the workload management properties.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram illustrating an exemplary system for assigning computational processes in a computer system to workload management classes.

FIG. 2 sets forth a block diagram of automated computing machinery representing a computer system useful in assigning computational processes to workload management classes.

FIG. 3 sets forth a flow chart illustrating an exemplary method for assigning computational processes to workload management classes.

FIG. 4 sets forth a flow chart illustrating a further exemplary method for assigning computational processes to workload management classes.

FIG. 5 sets forth a flow chart illustrating an exemplary method of assigning a process to a workload management class that includes determining whether the class was configured at install time.

### DETAILED DESCRIPTION OF EXEMPLARY EMBODIMENTS

### Introduction

The present invention is described to a large extent in this specification in terms of methods for assigning computational processes in a computer system to workload management classes. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Assigning Computational Processes in a Computer System to Workload Management Classes

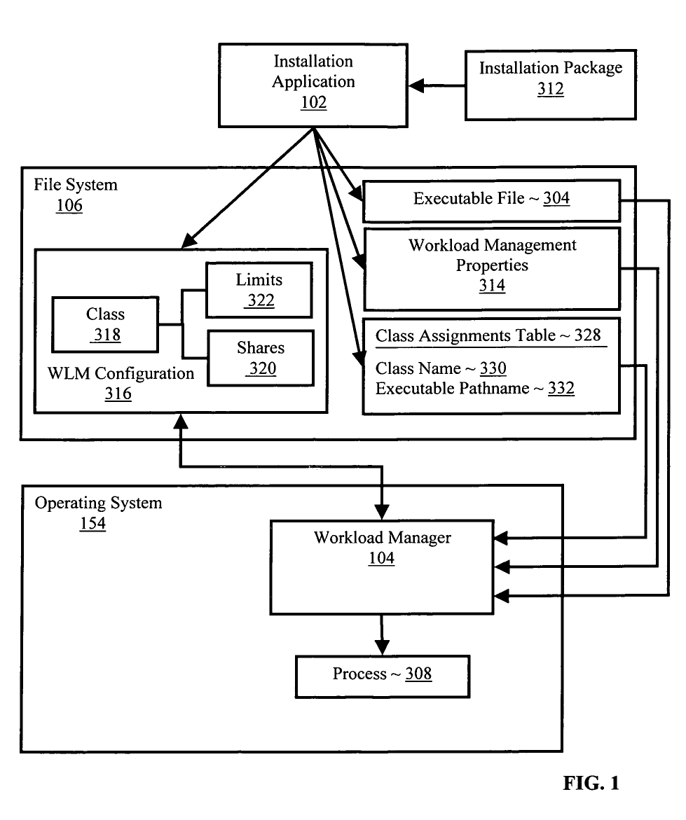

Exemplary methods, systems, and products are described for assigning computational processes in a computer system to workload management classes by reference to the accompanying drawings, beginning with FIG. 1. FIG. 1 sets forth a block diagram illustrating an exemplary system for assigning computational processes in a computer system to workload management classes that operates generally by installing on a computer system an executable file (304) from a software installation package (312), where the software installation package includes a specification (314) of workload management properties for the executable file, including a definition of a workload management class. The system of FIG. 1 also operates generally to execute a process (308) in dependence upon the executable file (304) and assign the process (308) to a workload management class (318).

The example of FIG. 1 includes an installation package (312) for installation on a computer system by installation application (102). An installation package is a collection of files, data files and executables, organized specially for ease of installation by use of an installation application. Installation application both package files for installation and install the packages. Examples of installation applications include the ‘Red Hat Package Manager’ (“RPM”) and IBM's InstallShield MutliPlatform™ (“ISMP”). Installation applications are typically capable of installation, uninstallation, verification, query support, and updates through a command line interface or an application programming interface (“API”). An installation package may organize files for installation according to products, bundles, filesets, and so on, and, installation package (312) also includes workload management properties (314) for the files in the installation package. The workload management properties include workload management class definitions. The installation package also includes class names stored in association with pathnames of executable files from which processes may be executed. Class names may be stored in association with pathnames of executable files in the form of a class assignment table or records for such a table.

Installation application (102) installs at least one executable file (304). As a practical matter, of course, each installation package may contain many files, hundreds or thousands of data files and executables. Installation application (102) also installs, from installation package (312), class assignment records in class assignment table (328), thereby associating class names (330) with pathnames (332) of executable files from which processes (308) may be executed through operating system (154). In this example, the existence of a record in the class assignment table represents the existence of a class assignment for a process created from a particular executable predetermined before run time by, for example, a manufacturer, a software developer, or an authorized user. Another way to indicate the existence of a predetermined class assignment is with a flag on the inode for the executable or an extended attribute on the executable itself. There may be other ways of indicating the existence of a predetermined class assignment for processes executed from executable files, and all such ways are well within the scope of the present invention.

Installation application may use the workload management properties (314) from the installation package (312) to configure one or more classes (318) whose properties are described in the workload management properties (314). Configuring such a class includes configuring entries in property tables for the class, including entries in a class table (318), a shares table (320), and a limits table (322). The class table includes class definitions for each class in a WLM configuration. The following exemplary entries of a class table:

```
db1:
        tier = 2
        inheritance = “yes”
        adminuser = “bob”
        authgroup = “devlt”
db2:
        tier = 1
        inheritance = “no”
```

shows a class definition for a class named“db1” whose member processes have processing priority of“2” and inherits the class of their parent processes upon execution - and a class definition for a class named“db2” whose member processes have processing priority of“1” and do not inherit their parents' classes.

A shares table defines share values for each class defined in a related class table. The following exemplary share table entries:

```
db1:
        CPU = 8
        memory = 20
        diskIO = 6
db2:
        memory = 12
        diskIO = 6
```

define CPU, memory, and disk share values of 8, 20, and 6 for class“db1” and memory and disk share values of 12 and 6 for class“db2.”

The number of shares of a resource for a class determines the proportion of the resource that is allocated to the processes assigned to the class. The resource shares are specified as relative amounts of usage between different classes in the same tier. In effect, resource shares are self-adapting percentages. The self-adaptation occurs according to the number of active classes. A class is considered active regardless of its resource consumption when it has at least one process assigned to it. For example, consider a system that has three classes defined, A, B, and C, whose share values for a resource are 50, 30, and 20 respectively.
If all three classes are active, the total number of shares for the active classes is 100. Their shares, expressed as percentages, are 50%, 30%, and 20%.
If A is not active, the total number of shares is 50—so each share represents 2%. The effective shares for B and C then become 60% and 40%.
If only one class is active, its share is 100%.

In this example, the sum of the shares for the three classes was 100 only for clarity of explanation. A share value can be any number supported by a particular WLM configuration.

A limits table defines minimum limits and soft and hard maximum limits for resources shared with processes in a class. The following exemplary limits table entries:

```
db1:
        CPU = 10%-100%;100%
        memory = 20%-100%;100%
        diskIO = 0%-33%;50%
db2:
        memory = 0%-20%;50%
        diskIO = 10%-66%;100%
```

establish a minimum and a soft and hard maximum for CPU allocation, memory, and diskIO for class“db1” of 10%, 100%, 100% - 20%, 100%, 100% - 0%, 33%, 50% respectively. The exemplary limits table entries also establish a minimum and a soft and hard maximum for memory and diskIO for class“db2” of 0%, 20%, 50% - 10%, 66%, 100% respectively. In this example, the limits are expressed as percentages. The minimum limit is a number between 0 and 100, and the maximum limits are numbers between 1 and 100. The hard maximum must be greater than or equal to the soft maximum, which must be greater than or equal to the minimum. Default values, when the limits are not specified for a class or a resource type, are 0 for the minimum and 100 for both the soft and hard maximum.

Installation application may not use the workload management properties (314) from the installation package (312) to configure classes (318) at install time. Alternatively, installation application (102) may install the workload management properties (314) themselves in a table established for that purpose on a file system (106). Such a table may have, for example, a structure that includes class name, tier, inheritance, shares, and share limits for each class defined in an installation package. The class name may be treated as a foreign key to the class assignment table (328), tying the class name (330) to an executable pathname (332). In this way, entries in the class assignment table (328) may represent in indication that a class assignment exists, defining a predetermined assignment of a process (executed from an executable file identified by the pathname (332)) to a class having a class name (330). If in executing a process from an executable file, workload manager (104) determines that a class assignment exists, but a class table entry for the class does not exist, workload manager (104), programmed to do so according to embodiments of the present invention, creates an entry in the class table for the class and configures shares and limits for the new class according to the provided workload management properties (314). In the exemplary system of FIG. 1 the workload manager assigns a process (308) to a workload management class (318).

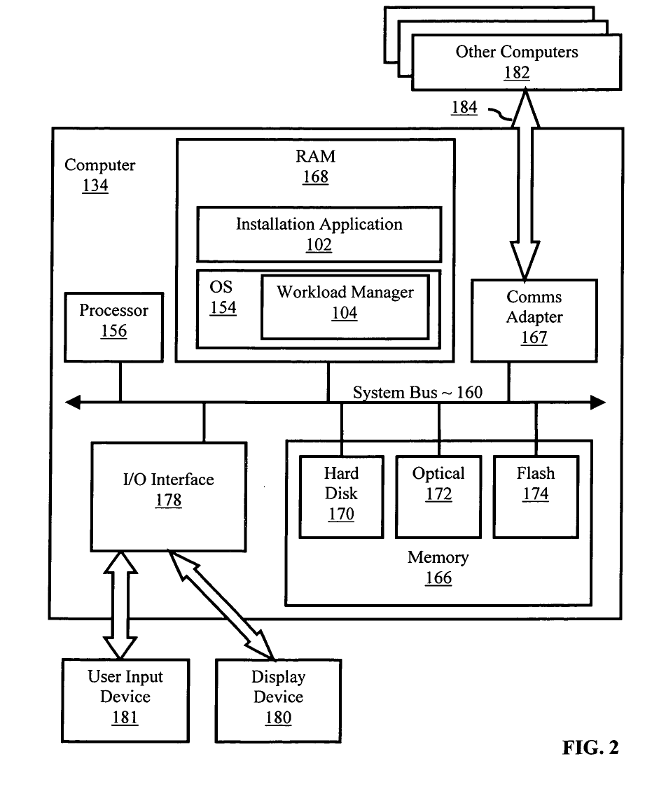

FIG. 2 sets forth a block diagram of automated computing machinery representing a computer system (134) useful in assigning computational processes to workload management classes according to embodiments of the present invention. The computer (134) of FIG. 2 includes at least one computer processor (156) or ‘CPU’ as well as random access memory (168)(“RAM”).

Stored in RAM (168) is an installation application program (102). The installation application (102) of FIG. 2 operates generally by installing on the computer system (134) an executable file from a software installation package, where the software installation package includes a specification of workload management properties for the executable file, including a definition of a workload management class. The installation package may be provided on an optical disk and read from optical drive (172) through system bus (160).

Also stored in RAM (168) is an operating system (154), including a workload manager (104). Operating systems useful in computers according to embodiments of the present invention include Unix, Linux, AIX™, Microsoft NT™, and many others as will occur to those of skill in the art. As discussed in more detail below, the workload manager provides functions operable through an API, through command line interfaces, or through graphical user interface (“GUI”) screens.

The computer (134) of FIG. 2 includes computer memory (166) coupled through a system bus (160) to processor (156) and to other components of the computer. Computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer (134) of FIG. 2 includes a communications adapter (167) for implementing connections for data communications (184), including connection through networks, to other computers (182), servers, clients, administrative devices, or sleeping devices. Communications adapters implement the hardware level of connections for data communications through which local devices and remote devices or servers send data communications directly to one another and through networks. Examples of communications adapters include modems for wired dial-up connections, Ethernet (IEEE 802.3) adapters for wired LAN connections, and 802.11b adapters for wireless LAN connections. Installation packages may be downloaded from other computers (182) to computer (134) through communications adapter (167).

The example computer of FIG. 2 includes one or more input/output interface adapters (178). Input/output interface adapters in computers implement user-oriented input/output through, for example, software drivers and computer hardware such as graphics adapters for controlling output to display devices (180) such as computer display screens, as well as user input from user input devices (181) such as keyboards and mice.

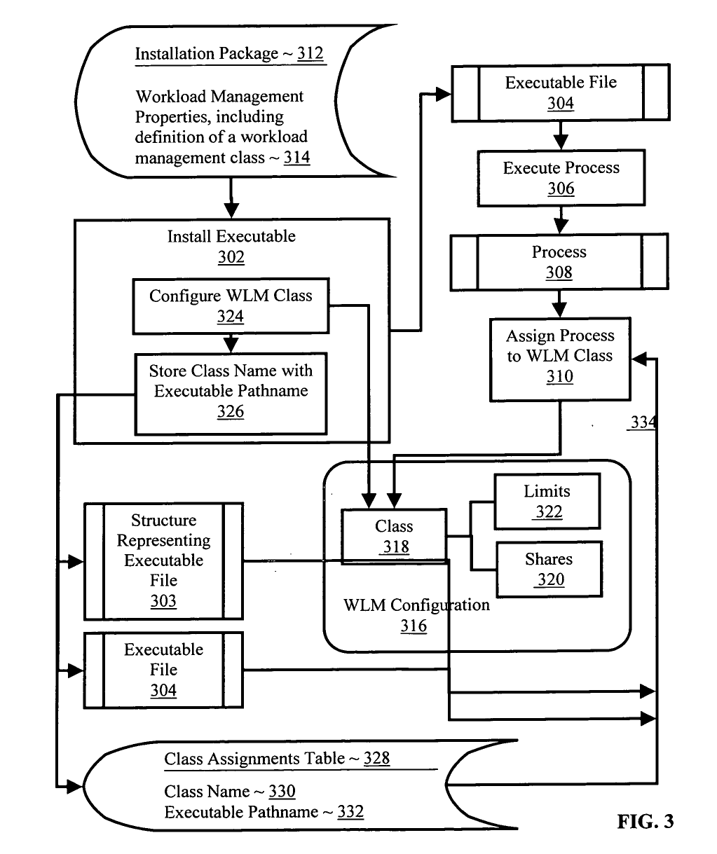

For further explanation, FIG. 3 sets forth a flow chart illustrating an exemplary method for assigning computational processes in a computer system to workload management classes that includes installing (302) on a computer system an executable file (304) from a software installation package (312). In the example of FIG. 3, the software installation package includes a specification (314) of workload management properties for the executable file that in turn includes, a definition of a workload management class.

In the method of FIG. 3, installing (302) software also includes configuring (324) the workload management class (318) in dependence upon the workload management properties (314) and storing (326) a class name (330) of the workload management class (318) in association with a pathname (332) for the executable file (304). That is, in this example, a class (318) is installed at the same time that executables are installed (302) on a file system from an installation package (312)—so that at run time, when a process (308) is executed (306) from the executable file (204), a class to which the process can be assigned already exists.

The example of FIG. 3 illustrates several ways of storing (326) a class name for the workload management class in association with a pathname for the executable file. Storing (326) a class name for the workload management class in association with a pathname for the executable file may be carried out by storing the class name in a class assignment table (328) established for the purpose of holding pathnames of executables and their associated class names. Alternatively, in the example of FIG. 3, storing (326) a class name for the workload management class in association with a pathname for the executable file may be carried out by storing the class name in the executable file (304) itself, such as, for example, in an extended attribute on the executable. A further method of storing (326) a class name for the workload management class in association with a pathname for the executable file shown in FIG. 3 is storing the class name in a data structure (303) that represents the executable file in an operating system. Examples of data structures representing executable files in operating system include Unix inodes, File Access Table (‘FAT’) entries in MSDOS, and entries in a Master File Table (‘MFT’) in Microsoft NT™.

The method of FIG. 3 also includes executing (306) a process (308) in dependence upon the executable file (304). Executing (306) a process (308) in dependence upon an executable file (304) is often carried out by a Unix exec( ) function that creates a process image from an executable file and replaces a current process image of the calling process with the new process image. Such an executable file is typically either an executable object file or a file of data for an interpreter.

The method of FIG. 3 also includes assigning (310) the process (308) to the workload management class (316). Notice that it is the process that is assigned, according to a process identifier or“PID.” An exec( ) provides no return value, because the calling process is replaced entirely with the executed process. A fork( ) call, on the other hand, creates a new process as a duplicate of the calling process and returns the PID of the new process. And an exec( ) call give its newly created process the PID of the calling process that is replaced by the executed process. An operating system shell that executes a process with an exec( ) call therefore may learn the PID of the executed process by calling fork( ) first to get the PID, and then allowing its duplicate to call exec( ), wiping out the duplicate and executing a process whose IPID is now known to the shell and therefore to the workload manager. Assigning (310) a process (308) to a workload management class (316) may be carried out through an operating system shell as illustrated in the following exemplary pseudocode:

```
null esh( )  { /* example shell */
    #include <sys/wlm.h>
    int wlm_assign (args)
    struct wlm_assign *args;
    main(int argc, char *arg_vector[ ]) {
        for (;;) {
            parse_input_line(arg_vector);
            if built_in_command(arg_vector[0]) {
                do_it(arg_vector);
                continue:
            } /* end built-in processing */
            pathname = find(arg_vector[0]);
            if (( pid = fork( )) == 0) {
                /*** child shell processing ***/
                execve(pathname, arg_vector, envp);
                exit(1); /* in case execve fails */
            }
            /*** parent shell processing ***/
            classname = find_classname(pathname);
            insert_in_wlm_assign(args, pid, classname);
            wlm_assign(args);
        } /* end for(;;) */
    } /* end main( ) */
} /* end esh( ) */
```

This pseudocode example illustrates shell operation according to embodiments of the present invention to assign a process to a class. In this example, fork( ) returns a PID of a child shell forked from the parent shell. The child shell executes a new process from an executable file identified by ‘pathname’ taken from a command line argument. The new process so executed inherits the PID of the process that executed it, the child shell. The parent shell now knows the PID of the new process (from the fork( ) return value) and the pathname of the executable file from which the new process was created—but does not yet know the class name of a class to which it may assign the new process. The parent shell looks up (334) the class name (330) of a class to which the new process may be assigned in a class assignment table (328) by searching the table for a record containing the pathname (332) of the executable file with the call to “classname=find_classname(pathname).” Alternatively, the shell may be programmed to obtain the class name (330) from the executable file (304) itself, such as, for example, by reading the class name from an extended attribute on the executable file, or from a data structure (303) representing the executable file in the operating system, such as, for example, a Unix inode.

Now knowing the class name and the PID, the parent shell has all the information it needs to assign (310) the process to a class. The parent shell, with a call to “insert_in_wlm_assign( args, pid, classname),” loads the class name and the PID into the parameter structure for the WLM API call. The parent shell then makes the actual WLM API call to assign the process represented by the ‘pid’ to the class identified by ‘classname’:“wlm_assign(args).”

Alternatively, the child process created by the execve( ), which is passed the executable pathname as a call parameter in the execve( ) call, can obtain its own PID from a system call to getpid( ) and look up a class name of a class to which the child process may be assigned in a class assignment table by searching the table for a record containing the pathname of the executable file. The child process can then make the WLM API call to assign the process to the workload management class.

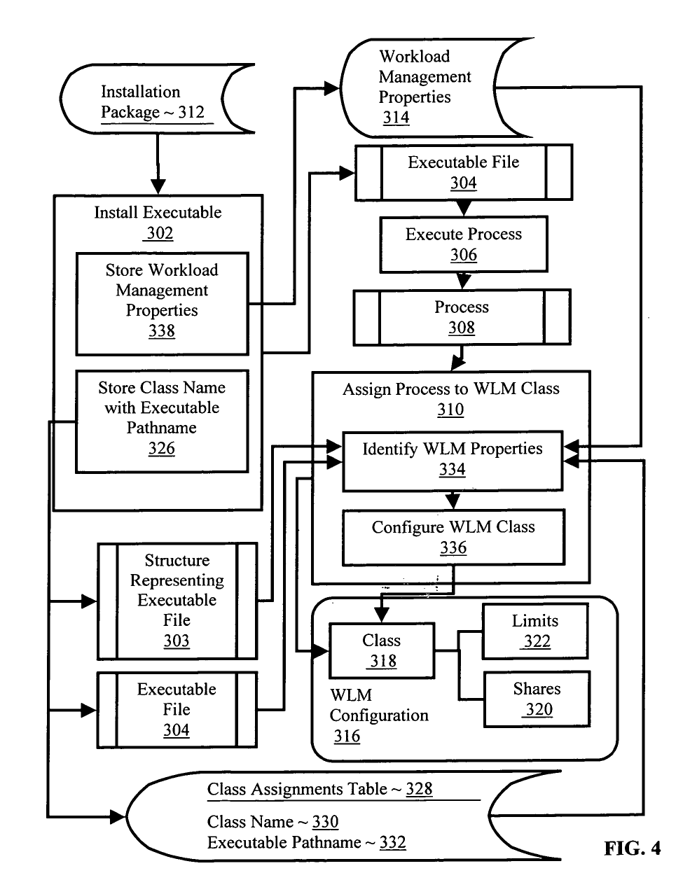

For further explanation, FIG. 4 sets forth a flow chart illustrating a further exemplary method for assigning computational processes in a computer system to workload management classes in which installing (302) an executable file includes storing (326) a class name (330) for the workload management class (328) in association with a pathname (332) for the executable file (304). In the example, of FIG. 4, a class for the process was not configured at install time, but workload management properties were installed on a file system as shown at reference (314) on FIG. 4 and on FIG. 1. In the example of FIG. 4, assigning (310) the process (308) to the workload management class (318) advantageously therefore includes identifying (334) the workload management properties (314) for the workload management class (318) in dependence upon the pathname (332) and configuring (336) the workload management class (318) in dependence upon the workload management properties (314). Identifying (334) the workload management properties (314) for the workload management class (318) in dependence upon the pathname (332) may be carried out by looking up the class name (330) of a class to which the new process may be assigned in a class assignment table (328), searching the table for a record containing the pathname (332) of the executable file. Alternatively, identifying (334) the workload management properties (314) for the workload management class (318) in dependence upon the pathname (332) may be carried out by obtaining the class name (330) from the executable file (304) itself or from a data structure (303) representing the executable file in the operating system, such as, for example, a Unix inode.

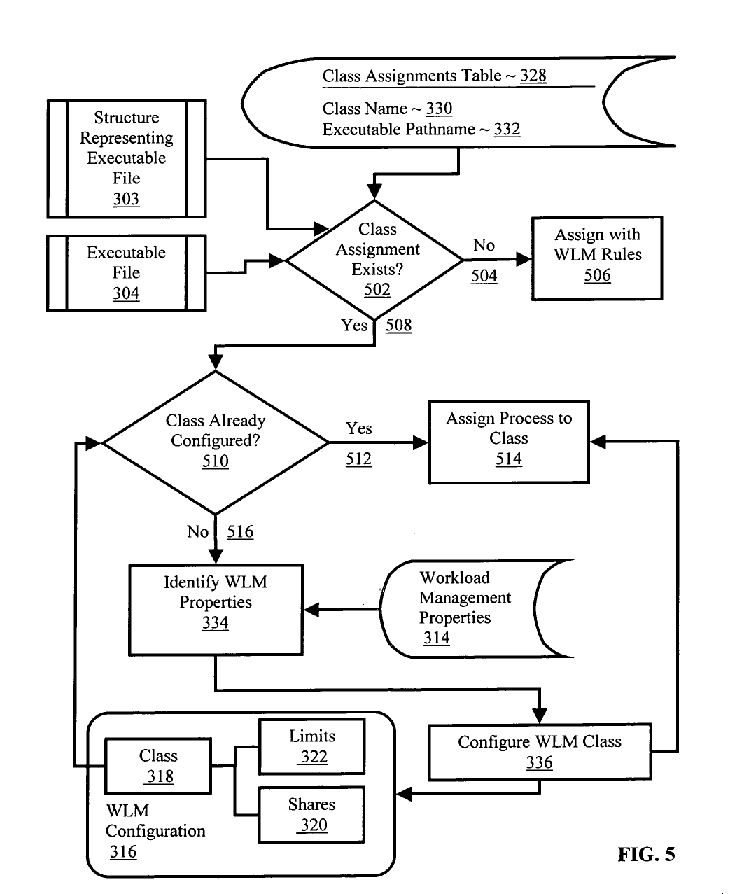

For further explanation, FIG. 5 sets forth a flow chart illustrating an exemplary method of assigning (310 on FIG. 4) a process to a workload management class that includes determining whether the class was configured at install time. The method of FIG. 5 includes determining (502) whether a class assignment exists for a process by searching a class assignment table (328) for a class assignment record for the pathname (332) from which the process was executed. A failure to find a class assignment record (504) may be taken as an indication that no class assignment exists for the process. Alternatively, determining (502) whether a class assignment exits may be carried out by examining the executable file (304) itself for an indication whether a class was assigned for it at install time or by examining a data structure (303) representing the executable file in the operating system, such as, for example, a Unix inode, for the same indication. If no class assignment exists for the process, the method of FIG. 5 includes assigning (506) the process to a workload management class in the usual fashion according to workload management rules.

If a class assignment exists (508), the method of FIG. 5 includes determining (510) whether the class is configured by searching the class table (318) for a class having the class name (330) associated with the pathname (332) in the class assignments table (328). If the class is already configured (512), the method of FIG. 5 includes assigning the process to the class (514) by calling the WLM API. If the class is not already configured, then method of FIG. 5 proceeds by identifying the WLM properties for the class from a workload management properties table (314) and configuring (336) the class by one or more calls to a WLM API. The method of FIG. 5 then proceeds by assigning (514) the process to the now-configured class with one or more WLM API calls. An exemplary shell that operates to assigning a process to a workload management class by determining whether the class was configured at install time may operate as illustrate in the following pseudocode segment:

```
null esh( ) { /* example shell */
    #include <sys/wlm.h>
    int wlm_assign (args);
    struct wlm_assign *args;
    int wlm_create_class (wlmargs);
    struct wlm_args *wlmargs;
main(int argc, char *arg_vector[ ]) {
    for (;;) {
        parse_input_line(arg_vector);
        if built_in_command(arg_vector[0]) {
            do_it(arg_vector);
            continue:
        } /* end built-in processing */
        pathname = find(arg_vector[0]);
        if (( pid = fork( )) == 0) {
            /*** child shell processing ***/
            execve(pathname, arg_vector, envp);
            exit(1); /* in case execve fails */
        }
        /*** parent shell processing ***/
        if ((classname = find_classname(pathname)) != null) {
            /*** class assignment exists ***/
            if((c = find_class(classname)) == null) {
                int wlm_create_class (wlmargs);
                struct wlm_args *wlmargs;
                load_wlmargs(wlmargs, WLM_Mgt_Props);
                wlm_create_class(wlmargs);
            }
            /*** class configuration exists ***/
            insert_in_wlm_assign(args, pid, classname);
            wlm_assign(args);
        }
```

| | |
|---|---|
| /*** | no class assignment exists, assign process to a class |
| | using traditional automatic WLM assignment rules |

```
            ***/
            else wlm_rules_assign(pid);
        } /* end for(;;) */
    } /* end main( ) */
} /* end esh( ) */
```

This pseudocode example illustrates shell operation according to embodiments of the present invention to assign a process to a class that includes determining whether the class was configured at install time. In this example, fork( ) returns a PID of a child shell forked from the parent shell. The child shell executes a new process from an executable file identified by ‘pathname’ taken from a command line argument. The new process so executed inherits the PID of the process that executed it, the child shell. The parent shell now knows the PID of the new process (from the fork( ) return value) and the pathname of the executable file from which the new process was created—but does not yet know the class name of a class to which it may assign the new process. Moreover, in this example, no such class name may exist. The parent shell looks up (334) the class name (330) of a class to which the new process may be assigned in a class assignment table (328) by searching the table for a record containing the pathname (332) of the executable file with the call to“classname=find_classname(pathname).”

If no class assignment record is found, that is taken as an indication that no class assignment exists for this process and that therefore assignment of the process to a class is to proceed by use of the traditional automatic WLM class assignment rules, carried out by a call to “wlm_rules_assign(pid).” A WLM API function such as “wlm_rules_assign(pid)” is fashioned according to embodiments of the present invention to invoke normal WLM run-time functioning to automatically assign a process to a class according to WKM class assignment rules, run-time functioning that typically in prior-art WLM installation could not be turned off or invoked or avoided by choice. Workload managers according to embodiments of the present invention are modified so that their automatic assignment by rules can be turned off unless invoked as illustrated by“wlm_rules_assign(pid).”

If a class assignment record is found, the find_classname( ) function returns the class name of a class to which the process is to be assigned. Now knowing the class name and the PID, the parent shell has all the information it needs to assign (310) the process to a class, if the class exists. The parent shell determines through a call to “if((c=find_class(classname))==null)” whether the pertinent class has yet been configured on the system. If the class is already configured, that means that it was configured at install time or at a previous run time for this or some other process. If the class is not already configured, the parent shell configures the class with the calls:

load_wlmargs(wlmargs, WLM_Mgt_Props);
wlm_create_class(wlmargs);

The call“load_wlmargs(wlmargs, WLM_Mgt_Props)” loads workload management properties (314) into the call parameter structure for the API call “wlm_create_class(wlmargs),” which in turn configures the new class complete with WLM share values and WLM limit values. Now the parent shell has a class to work with, regardless whether the class was configured at install time or run time. The parent shell, with a call to “insert_in_wlm_assign( args, pid, classname),” loads the class name and the PID into the parameter structure for the WLM API call. The parent shell then makes the actual WLM API call to assign the process represented by the ‘pid’ to the class identified by ‘classname’:“wlm_assign(args).”

Although the method of FIG. 5 is illustrated with the process carried out in a parent shell process, alternatively, the child process created by the execve( ), which is passed the executable pathname as a call parameter in the execve( ) call, may be programmed to obtain its own PID from a system call to getpid( ). The child process can then determine whether a class configuration for it already exists, assign itself to the class if it already exists, and configure the class if it does not yet exist.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for assigning computational processes in a computer system to workload management classes, the method comprising:
installing on the computer system an executable file from a software installation package, wherein the software installation package includes a specification of workload management properties for the executable file, including a definition of a workload management class;
executing a process in dependence upon the executable file; and
assigning the process to the workload management class.

2. The method of claim 1 wherein the workload management class definition further comprises a class name, a priority ranking, and an inheritance attribute.

3. The method of claim 1 wherein the specification of workload management properties further comprises minimum values and maximum values for CPU, memory, and disk I/O shares for the executable file.

4. The method of claim 1 wherein installing an executable file further comprises:
configuring the workload management class in dependence upon the workload management properties; and
storing a class name of the workload management class in association with a pathname for the executable file.

5. The method of claim 1 wherein installing an executable file further comprises storing a class name for the workload management class in association with a pathname for the executable file.

6. The method of claim 5 wherein storing a class name for the workload management class in association with a pathname for the executable file further comprises storing the class name in the executable file.

7. The method of claim 5 wherein storing a class name for the workload management class in association with a pathname for the executable file further comprises storing the class name in a data structure that represents the executable file in an operating system.

8. The method of claim 5 wherein assigning the process to the workload management class further comprises:
identifying the workload management properties for the workload management class in dependence upon the pathname; and
configuring the workload management class in dependence upon the workload management properties.

9. A system for assigning computational processes to workload management classes, the system comprising:
means for installing on a computer system an executable file from a software installation package, wherein the software installation package includes a specification of workload management properties for the executable file, including a definition of a workload management class;
means for executing a process in dependence upon the executable file; and
means for assigning the process to the workload management class.

10. The system of claim 9 wherein the workload management class definition further comprises a class name, a priority ranking, and an inheritance attribute.

11. The system of claim 9 wherein the specification of workload management properties further comprises minimum values and maximum values for CPU, memory, and disk I/O shares for the executable file.

12. The system of claim 9 wherein means for installing the executable file further comprises:
means for configuring the workload management class in dependence upon the workload management properties; and
means for storing a class name of the workload management class in association with a pathname for the executable file.

13. The system of claim 9 wherein means for installing an executable file further comprises means for storing a class name for the workload management class in association with a pathname for the executable file.

14. The system of claim 13 wherein means for assigning the process to the workload management class further comprises:
means for identifying the workload management properties for the workload management class in dependence upon the pathname; and
means for configuring the workload management class in dependence upon the workload management properties.

15. A computer program product for assigning computational processes in a computer system to workload management classes, the computer program product comprising:
a recording medium;
means, recorded on the recording medium, for installing on the computer system an executable file from a software installation package, wherein the software installation package includes a specification of workload management properties for the executable file, including a definition of a workload management class;
means, recorded on the recording medium, for executing a process in dependence upon the executable file; and
means, recorded on the recording medium, for assigning the process to the workload management class.

16. The computer program product of claim 15 wherein the workload management class definition further comprises a class name, a priority ranking, and an inheritance attribute.

17. The computer program product of claim 15 wherein the specification of workload management properties further comprises minimum values and maximum values for CPU, memory, and disk I/O shares for the executable file.

18. The computer program product of claim 15 wherein means, recorded on the recording medium, for installing the executable file further comprises:
means, recorded on the recording medium, for configuring the workload management class in dependence upon the workload management properties; and
means, recorded on the recording medium, for storing a class name of the workload management class in association with a pathname for the executable file.

19. The computer program product of claim 15 wherein means, recorded on the recording medium, for installing an executable file further comprises means, recorded on the recording medium, for storing a class name for the workload management class in association with a pathname for the executable file.

20. The computer program product of claim 19 wherein means, recorded on the recording medium, for assigning the process to the workload management class further comprises:
means, recorded on the recording medium, for identifying the workload management properties for the workload management class in dependence upon the pathname; and
means, recorded on the recording medium, for configuring the workload management class in dependence upon the workload management properties.
